(19) United States
(12) Patent Application Publication
(10) Pub. No.: US 2026/0170504 A1
(43) Pub. Date: Jun. 18, 2026

(54) PAYMENT RISK CONTROL METHOD AND APPARATUS, STORAGE MEDIUM, AND ELECTRONIC DEVICE

(71) Applicant: Alipay Payment Technology Co., Ltd., Shanghai (CN)

(72) Inventor: Xiaolei YU, Shanghai (CN)

(21) Appl. No.: 19/417,984

(22) Filed: Dec. 12, 2025

(30) Foreign Application Priority Data
Dec. 16, 2024 (CN) 202411856566.4

(51) Int. Cl. G06Q 20/40; G06F 3/14

(52) U.S. Cl. CPC G06Q 20/4016; G06F 3/1454

(57) ABSTRACT

A payment risk control method includes: obtaining, in response to a payment triggering operation performed by a user, a screen sharing status corresponding to user equipment currently used by the user; and in response to the screen sharing status indicating that the user equipment is currently in screen sharing, performing a risk control operation corresponding to the payment triggering operation based on the screen sharing status.

### CROSS-REFERENCE TO RELATED APPLICATIONS

This application is based upon and claims priority to Chinese Patent Application No. 202411856566.4, filed on Dec. 16, 2024, the entire content of which is incorporated herein by reference.

### TECHNICAL FIELD

The present disclosure relates to the field of computer technologies, and in particular, to a payment risk control method and apparatus, a storage medium, and an electronic device.

### BACKGROUND

In the conventional technology, fraudsters may commit fraud by using a screen sharing function, and the fraudsters sometimes induce victims to download formal video conferencing software for communication. Because such formal video conferencing software has a large quantity of manufacturers and a high market demand, and can be applied to various conference scenarios, functional limitations cannot be imposed on the formal video conferencing software, and implementing early warning or countermeasures through the video conferencing software yields limited effectiveness.

### SUMMARY

According to a first aspect of this specification, a payment risk control method includes: obtaining, in response to a payment triggering operation performed by a user, a screen sharing status corresponding to user equipment currently used by the user; and in response to the screen sharing status indicating that the user equipment is currently in screen sharing, performing a risk control operation corresponding to the payment triggering operation based on the screen sharing status.

According to a second aspect of this specification, an electronic device includes: a processor and a storage storing instructions executable by the processor. The processor is configured to: obtain, in response to a payment triggering operation performed by a user, a screen sharing status corresponding to user equipment currently used by the user; and in response to the screen sharing status indicating that the user equipment is currently in screen sharing, perform a risk control operation corresponding to the payment triggering operation based on the screen sharing status.

According to a third aspect of this specification, a non-transitory storage medium stores instructions that, when executed by a processor of an electronic device, cause the electronic device to perform the payment risk control method in the first aspect.

### BRIEF DESCRIPTION OF DRAWINGS

FIG. 1 is a flowchart of a payment risk control method according to an embodiment.

FIG. 2 is a schematic diagram of a payment risk control apparatus according to an embodiment.

FIG. 3 is a schematic diagram of an electronic device according to an embodiment.

### DETAILED DESCRIPTION OF EMBODIMENTS

The following describes example embodiments of this specification with reference to the accompanying drawings. Clearly, the described embodiments are merely some but not all of embodiments of this specification. All other embodiments obtained by a person of ordinary skill in the art based on the embodiment of this specification without creative efforts shall fall within the protection scope of this specification.

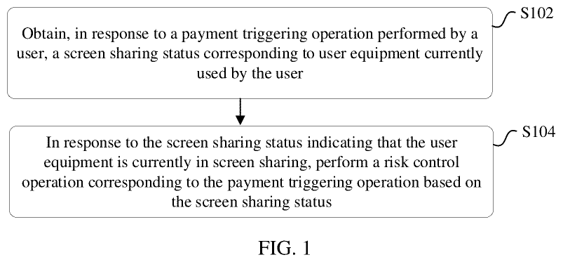

FIG. 1 is a flowchart of a payment risk control method according to an embodiment. In this embodiment, the payment risk control method is applied to a payment risk control apparatus or an electronic device in which a payment risk control apparatus is configured. As shown in FIG. 1, the payment risk control method can include the following steps.

S102: Obtain, in response to a payment triggering operation performed by a user, a screen sharing status corresponding to user equipment currently used by the user.

In some embodiments, the payment triggering operation includes but is not limited to any operation that is performed by the user and that is used to trigger a payment behavior, for example, an operation used to trigger display of a payment code (for example, the user taps a “payment code” button), an operation used to trigger a transfer or sending of a red packet (for example, the user taps a “transfer” button or a “send red packet” button), an operation used to trigger entry into a payment page (for example, the user taps a “pay” button), or an operation used to trigger opening or login of a payment application (for example, the user taps an icon of a payment application on a home screen of the user equipment currently used by the user, or the user taps a “log in” button). It should be noted that the payment operation is merely an example and not a limitation. A person skilled in the art should understand that any operation used to trigger a specific payment behavior can be included in the protection scope of this specification.

In some embodiments, the screen sharing status corresponding to the user equipment currently used by the user is obtained in response to the payment triggering operation performed by the user. The user equipment includes but is not limited to any electronic device that can perform man-machine interaction with the user (e.g., by using a touchpad), such as a smartphone, a tablet computer, or a personal computer (PC). The electronic device can use any operating system, for example, an Android operating system, an iOS operating system, or a Windows operating system. In some embodiments, in addition to indication information used to indicate whether the user equipment is currently engaged in screen sharing, the screen sharing status further includes but is not limited to screen sharing duration, a screen sharing enabling time, screen content shared by the user equipment, an operation record corresponding to the user equipment in a screen sharing period, etc. Specific content of the screen sharing status is not limited in this specification. In some embodiments, screen sharing means that the user shares screen content of the user equipment currently used by the user with another person in real time. Through screen sharing, a participant can view a home screen, an application, or a specific window of a sharer.

In some embodiments, the screen sharing status corresponding to the user equipment currently used by the user can be obtained by invoking an interface provided by the user equipment, or the screen sharing status corresponding to the user equipment can be obtained from a notification message by monitoring the notification message sent by the user equipment. For example, when the screen sharing status changes, the user equipment sends a corresponding notification message. For another example, the user equipment sends a corresponding notification message at a preset time interval in a screen sharing process. A specific manner of obtaining the screen sharing status corresponding to the user equipment is not limited in this specification. For example, the user equipment is a mobile phone or a tablet computer that uses an iOS operating system. An API of UIScreen (UIScreen is a class in iOS development, and is used to represent a screen of a device) is invoked to determine whether a current screen of the user equipment is being recorded, mirrored, or sent through AirPlay. When UIScreen.isCaptured is true, it indicates that the current screen of the user equipment is being recorded, mirrored, or sent through AirPlay, and it can be determined that the user equipment is currently engaged in screen sharing. When UIScreen.isCaptured is false, it can be determined that the user equipment is currently not engaged in screen sharing. For another example, when a screen recording status changes, UIKit (UIKit is a group of frameworks used to construct a user interface in iOS development) sends a UIScreenCapturedDidChange notification (notification message). Herein, UIScreenCapturedDidChangeNotification is a notification in the iOS system, and is used to notify an application of whether a current screen is being recorded. When the screen recording status changes, UIKit sends the notification. It can be learned, by monitoring the notification, whether a current screen of the user equipment is being recorded, and it is further determined whether the user equipment is currently engaged in screen sharing.

S104: In response to the screen sharing status indicating that the user equipment is currently in screen sharing, perform a risk control operation corresponding to the payment triggering operation based on the screen sharing status.

In some embodiments, if the screen sharing status indicates that the user equipment is currently engaged in screen sharing, the risk control operation corresponding to the payment triggering operation currently performed by the user is further determined based on the screen sharing status, and the risk control operation is performed. The risk control operation includes but is not limited to any operation for performing risk control on the payment triggering operation. For example, the risk control operation can be to block a payment behavior triggered by the payment triggering operation, that is, to stop the payment behavior, or can be to provide an interactive reminder to the user for the payment triggering operation, so that the user determines whether to continue with a payment behavior triggered by the payment triggering operation, or can be to allow a payment behavior triggered by the payment triggering operation to proceed, that is, to continue with the payment behavior. For example, if the payment triggering operation is an operation used to trigger display of a payment code, the risk control operation corresponding to the payment triggering operation can be to prohibit display of the payment code. For another example, if the payment triggering operation is an operation used to trigger a transfer, the risk control operation corresponding to the payment triggering operation can be to block the transfer, or can be to provide an interactive reminder to the user, so that the user determines whether to continue with the transfer, or can be to allow the transfer to proceed.

In some embodiments, the corresponding risk control operation needs to be determined based on the screen sharing status. For example, the risk control operation to which the screen sharing status is mapped is obtained based on a preset mapping relationship between a screen sharing status and a risk control operation. For example, the risk control operation to which the screen sharing status is mapped is obtained based on the screen sharing duration in the screen sharing status. For another example, the screen sharing status is input into a trained risk control prediction model to obtain a risk control operation output by the risk control prediction model. A model structure, a model parameter, and a model training manner of the risk control prediction model are not limited herein in this specification. For example, a screenshot of the user equipment obtained based on a preset time interval in the screen sharing period is input into a trained risk control prediction model to obtain a risk control operation output by the risk control prediction model.

In the above embodiments, when a user performs a payment triggering operation, it is identified, based on a screen sharing status corresponding to user equipment currently used by the user, whether the user is in a high-risk, fraud-prone screen sharing environment, and a risk control operation corresponding to the payment triggering operation is performed. It is sensed whether a potential fraud victim is in a screen sharing environment, to perform proactive protection, early warning, or timely blocking and interception. This can significantly lower a risk that the user is guided to fraud in the screen sharing status, and can greatly lower a risk that the user is defrauded in a payment scenario.

In some embodiments, the performing the risk control operation corresponding to the payment triggering operation based on the screen sharing status includes: determining corresponding risk quantization information based on the screen sharing status; and performing the risk control operation corresponding to the payment triggering operation based on the risk quantization information. In some embodiments, the risk quantization information is used to quantize a risk degree of a current payment environment of the user equipment. For example, the risk quantization information can be in a value form, or can be in a string form (for example, a high risk, a medium risk, or a low risk). A specific form of the risk quantization information is not limited in this specification. In some embodiments, the corresponding risk quantization information needs to be first determined based on the screen sharing status. For example, the screen sharing status is input into a preset function equation to obtain risk quantization information output by the function equation. For example, the screen sharing duration in the screen sharing status is input into a preset function equation to obtain risk quantization information output by the function equation. For another example, the screen sharing status is input into a trained risk control quantization model to obtain risk quantization information output by the risk control quantization model. A model structure, a model parameter, and a model training manner of the risk control quantization model are not limited herein in this specification. For example, the screenshot of the user equipment obtained based on the preset time interval in the screen sharing period is input into a trained risk control quantization model to obtain risk quantization information output by the risk control quantization model. In some embodiments, the risk control operation corresponding to the payment triggering operation currently performed by the user further needs to be determined based on the obtained risk quantization information, and the risk control operation is performed. For example, if the risk quantization information is in a value form, a risk control operation to which a value range within which the risk quantization information falls is mapped can be used as the risk control operation corresponding to the payment triggering operation based on the value range within which the risk quantization information falls and a preset mapping relationship between a value range and a risk control operation. For another example, if the risk quantization information is in a string form, a risk control operation to which the risk quantization information is mapped can be used as the risk control operation corresponding to the payment triggering operation based on a preset mapping relationship between a string and a risk control operation.

In some embodiments, the screen sharing status includes an operation record and screen sharing duration information that correspond to the user equipment in a screen sharing period; and the determining corresponding risk quantization information based on the screen sharing status includes: determining the corresponding risk quantization information based on the operation record, the screen sharing duration information, device risk quantization information corresponding to the user equipment, and transaction volume quantization information corresponding to the user. In some embodiments, the operation record includes operation information related to at least one operation performed by the user equipment in the screen sharing period, and the operation information includes but is not limited to an operation time, an operation target, an operation object, operation content, an operation type, an operation result, etc. This is not limited in this specification. In some embodiments, the at least one operation can be classified based on the operation information of the at least one operation in the operation record, for example, a page access type, a fund operation type, and an account operation type. Each classification corresponds to a preset variable, and therefore a variable corresponding to the operation record can be obtained. In some embodiments, the device risk quantization information can be formed by using a preset algorithm based on device information of the user equipment, for example, a model, an operating system version, whether device rebinding is performed, and whether the user equipment is a commonly used device. The device risk quantization information is used to represent a risk degree (for example, trusted, a medium risk, or a high risk) of the user equipment in a variable form. In some embodiments, historical transactions of the user are classified based on a time dimension, to dynamically monitor a transaction volume of the user. The transaction volume quantization information of the user is obtained. The transaction volume quantization information is used to represent a transaction risk degree of the user in a variable form. In some embodiments, the variable corresponding to the operation record, the screen sharing duration information, the device risk quantization information, and the transaction volume quantization information can be respectively multiplied by custom weights respectively corresponding to the variables, and then weighted summation can be performed, and the corresponding risk quantization information is determined based on a calculation result. The calculation result can be directly used as the risk quantization information. In some embodiments, the calculation result can be multiplied by a preset custom weight to obtain the risk quantization information. In some embodiments, risk quantization information to which the calculation result is mapped or risk quantization information to which a value range within which the calculation result falls is mapped can be obtained based on a preset mapping relationship. In some embodiments, the calculation result can be input into a trained risk quantization model to obtain risk quantization information output by the model. A specific manner of obtaining the risk quantization information based on the calculation result obtained through weighted summation is not limited herein in this specification.

In some embodiments, the determining the corresponding risk quantization information based on the operation record, the screen sharing duration information, device risk quantization information corresponding to the user equipment, and transaction volume quantization information corresponding to the user includes: determining the corresponding risk quantization information based on the operation record, the screen sharing duration information, the device risk quantization information corresponding to the user equipment, the transaction volume quantization information corresponding to the user, and social relationship quantization information between the user and a payment object corresponding to the payment triggering operation. In some embodiments, if the payment triggering operation has a corresponding payment object, for example, if the payment triggering operation is an operation used to trigger a transfer or sending of a red packet, the payment object corresponding to the payment triggering operation is a transfer object or a red packet sending object. In this case, a social relationship between the user and the payment object needs to be quantized to obtain the corresponding social relationship quantization information. The social relationship quantization information is used to represent a risk degree of the social relationship between the user and the payment object in a variable form. For example, the corresponding social relationship quantization information can be generated based on information such as whether the payment object is a friend of the user, a historical transaction record between the user and the payment object, transaction content of current payment, and remarks of the user for the current payment. This is not limited in this specification. In some embodiments, the variable corresponding to the operation record, the screen sharing duration information, the device risk quantization information, the transaction volume quantization information, and the social relationship quantization information can be respectively multiplied by custom weights respectively corresponding to the variables, and then weighted summation can be performed, and the corresponding risk quantization information is determined based on a calculation result. A specific manner of obtaining the risk quantization information based on the calculation result obtained through weighted summation is described above in detail. Details are not described herein.

In some embodiments, the screen sharing status includes screen content shared by the user equipment; and the performing the risk control operation corresponding to the payment triggering operation based on the screen sharing status includes: performing the risk control operation corresponding to the payment triggering operation based on the screen content shared by the user equipment. In some embodiments, the screen sharing status includes the screen content shared by the user equipment, and the screen content includes but is not limited to a page identifier, a page name, a page type, page-presented content (for example, a text or an image), page sharing duration, a page sharing start time, a page sharing end time, etc. that are of a currently displayed page of the user equipment in a screen sharing period. This is not limited in this specification. In some embodiments, the risk control operation corresponding to the payment triggering operation currently performed by the user can be determined based on the screen content shared by the user equipment, and the risk control operation is performed. For example, a sensitivity level corresponding to the currently displayed page is determined based on the page identifier of the currently displayed page of the user equipment in the screen sharing period in the screen content, and then a risk control operation to which the sensitivity level is mapped is used as the risk control operation corresponding to the payment triggering operation based on a preset mapping relationship between a sensitivity level and a risk control operation. For another example, it is first determined, based on the page type of the currently displayed page of the user equipment in the screen sharing period in the screen content, whether the currently displayed page is a sensitive page, and if yes, based on a duration interval within which page sharing duration of the sensitive page in the screen content falls and a preset mapping relationship between a duration interval and a risk control operation, a risk control operation to which the duration interval is mapped is used as the risk control operation corresponding to the payment triggering operation.

In some embodiments, the performing the risk control operation corresponding to the payment triggering operation based on the screen content shared by the user equipment includes: performing the risk control operation corresponding to the payment triggering operation based on sensitive information included in the screen content shared by the user equipment. In some embodiments, sensitive information included in the page-presented content can be first obtained based on the page-presented content of the currently displayed page of the user equipment in the screen sharing period in the screen content. A specific method can be:
performing keyword recognition on text information in the page-presented content to obtain the sensitive information included in the page-presented content, or performing image content recognition on image information in the page-presented content to obtain the sensitive information included in the page-presented content. A manner of obtaining the sensitive information from the page-presented content is not limited in this specification. In some embodiments, after the sensitive information included in the screen content shared by the user equipment is obtained, the risk control operation corresponding to the payment triggering operation currently performed by the user can be determined based on the sensitive information, and the risk control operation is performed. For example, based on a sensitivity level corresponding to the sensitive information and a preset mapping relationship between a sensitivity level and a risk control operation, a risk control operation to which the sensitivity level is mapped is used as the risk control operation corresponding to the payment triggering operation. For another example, the sensitive information is directly input into a trained risk control prediction model, and a risk control operation output by the model is used as the risk control operation corresponding to the payment triggering operation.

In some embodiments, the performing the risk control operation corresponding to the payment triggering operation based on sensitive information included in the screen content shared by the user equipment includes: performing the risk control operation corresponding to the payment triggering operation based on association information between the sensitive information included in the screen content shared by the user equipment and screen-presented content of the user equipment within a preset time range before a screen sharing enabling time. In some embodiments, the preset time range can be a time range of predetermined duration before the screen sharing enabling time, or can be a time range from a most recent power-on time or a most recent unlock time of the user equipment to the screen sharing enabling time. This is not limited in this specification. In some embodiments, the screen-presented content of the user equipment within the preset time range before the screen sharing enabling time includes but is not limited to a page identifier, a page name, a page type, page-presented content (for example, a text or an image), page sharing duration, a page sharing start time, a page sharing end time, etc. that are of a currently displayed page of the user equipment within the preset time range before the screen sharing enabling time. This is not limited in this specification. In some embodiments, the risk control operation corresponding to the payment triggering operation currently performed by the user is determined based on the association information between the sensitive information included in the screen content shared by the user equipment and the screen-presented content of the user equipment within the preset time range before the screen sharing enabling time, and the risk control operation is performed. The association information can refer to an association degree between the sensitive information and the screen-presented content, and the corresponding risk control operation is determined based on the association degree. For example, based on a value interval within which a value corresponding to the association degree falls and a preset mapping relationship between a value interval and a risk control operation, a risk control operation to which the value interval is mapped is used as the risk control operation corresponding to the payment triggering operation. The association information can also refer to a degree of guidance between the sensitive information and the screen-presented content in terms of semantic logic. The degree of guidance is used to represent an extent to which the screen-presented content guides the sensitive information in terms of semantic logic. Then, the corresponding risk control operation is determined based on the degree of guidance. For example, a risk control operation to which the degree of guidance is mapped is used as the risk control operation corresponding to the payment triggering operation based on a preset mapping relationship between a degree of guidance and a risk control operation.

In some embodiments, the performing the risk control operation corresponding to the payment triggering operation based on sensitive information included in the screen content shared by the user equipment includes: performing the risk control operation corresponding to the payment triggering operation based on association information between the sensitive information included in the screen content shared by the user equipment and an operation object corresponding to the payment triggering operation. In some embodiments, if the payment triggering operation is an operation used to trigger display of a payment code, the corresponding operation object is the payment code; if the payment triggering operation is an operation used to trigger entry into a payment page, the corresponding operation object is the payment page; if the payment triggering operation is an operation used to trigger opening or login of a payment application, the corresponding operation object is the payment application; or if the payment triggering operation is an operation used to trigger a transfer or sending of a red packet, the corresponding operation object is a transfer object or a red packet sending object. In some embodiments, the risk control operation corresponding to the payment triggering operation currently performed by the user is determined based on the association information between the sensitive information included in the screen content shared by the user equipment and the operation object corresponding to the payment triggering operation, and the risk control operation is performed. The association information can refer to an association degree between the sensitive information and the operation object, and the corresponding risk control operation is determined based on the association degree. For example, a risk control operation to which the association degree is mapped is used as the risk control operation corresponding to the payment triggering operation based on a preset mapping relationship between an association degree and a risk control operation. The association information can also refer to a degree of guidance between the sensitive information and the operation object in terms of semantic logic. The degree of guidance is used to represent an extent to which the sensitive information guides the operation object in terms of semantic logic. Then, the corresponding risk control operation is determined based on the degree of guidance. For example, based on a value interval within which a value corresponding to the degree of guidance falls and a preset mapping relationship between a value interval and a risk control operation, a risk control operation to which the value interval is mapped is used as the risk control operation corresponding to the payment triggering operation.

In some embodiments, the screen sharing status includes an operation record corresponding to the user equipment in a screen sharing period; and the performing the risk control operation corresponding to the payment triggering operation based on the screen sharing status includes: performing the risk control operation corresponding to the payment triggering operation based on the operation record corresponding to the user equipment in the screen sharing period. In some embodiments, the operation record includes operation information related to at least one operation performed by the user equipment in the screen sharing period, and the operation information includes but is not limited to an operation time, an operation target, an operation object, operation content, an operation type, an operation result, etc. This is not limited in this specification. In some embodiments, the risk control operation corresponding to the payment triggering operation currently performed by the user can be determined based on the operation record corresponding to the user equipment in the screen sharing period, and the risk control operation is performed. For example, the operation record is input into a trained risk control prediction model, and a risk control operation output by the model is used as the risk control operation corresponding to the payment triggering operation. For another example, based on the operation type of the at least one operation in the operation record and a preset mapping relationship between an operation type and a risk control operation, a risk control operation to which the operation type is mapped is used as the risk control operation corresponding to the payment triggering operation.

In some embodiments, the performing the risk control operation corresponding to the payment triggering operation based on the operation record corresponding to the user equipment in the screen sharing period includes: performing the risk control operation corresponding to the payment triggering operation based on a sensitive operation involved in the operation record corresponding to the user equipment in the screen sharing period. In some embodiments, a sensitive operation involved in the at least one operation can be determined based on the operation information of the at least one operation in the operation record, and then the risk control operation corresponding to the payment triggering operation currently performed by the user is determined based on the sensitive operation, and the risk control operation is performed. For example, based on sensitivity level information corresponding to the sensitive operation and a preset mapping relationship between sensitivity level information and a risk control operation, a risk control operation to which the sensitivity level information is mapped can be used as the risk control operation corresponding to the payment triggering operation. For another example, operation content of the sensitive operation can be input into a trained risk control prediction model, and a risk control operation output by the model is used as the risk control operation corresponding to the payment triggering operation.

In some embodiments, the performing the risk control operation corresponding to the payment triggering operation based on a sensitive operation involved in the operation record corresponding to the user equipment in the screen sharing period includes: performing the risk control operation corresponding to the payment triggering operation based on association information between the sensitive operation involved in the operation record corresponding to the user equipment in the screen sharing period and a historical operation performed by the user equipment within a preset time range before a screen sharing enabling time. In some embodiments, the preset time range can be a time range of predetermined duration before the screen sharing enabling time, or can be a time range from a most recent power-on time or a most recent unlock time of the user equipment to the screen sharing enabling time. This is not limited in this specification. In some embodiments, the risk control operation corresponding to the payment triggering operation currently performed by the user can be determined based on association information between the operation information of the at least one operation in the operation record corresponding to the user equipment in the screen sharing period and operation information of the historical operation performed by the user equipment within the preset time range before the screen sharing enabling time, and the risk control operation is performed. The operation information includes but is not limited to an operation time, an operation target, an operation object, operation content, an operation type, an operation result, etc. This is not limited in this specification. In some embodiments, the association information can refer to an association degree between the sensitive operation and the historical operation, and the corresponding risk control operation is determined based on the association degree. For example, based on a value interval within which a value corresponding to the association degree falls and a preset mapping relationship between a value interval and a risk control operation, a risk control operation to which the value interval is mapped is used as the risk control operation corresponding to the payment triggering operation. The association information can also refer to a degree of guidance between the historical operation and the sensitive operation. The degree of guidance is used to represent an extent to which the historical operation guides the sensitive operation. Then, the corresponding risk control operation is determined based on the degree of guidance. For example, a risk control operation to which the degree of guidance is mapped is used as the risk control operation corresponding to the payment triggering operation based on a preset mapping relationship between a degree of guidance and a risk control operation.

In some embodiments, the performing the risk control operation corresponding to the payment triggering operation based on the sensitive operation involved in the operation record corresponding to the user equipment in the screen sharing period includes: performing the risk control operation corresponding to the payment triggering operation based on association information between the sensitive operation involved in the operation record corresponding to the user equipment in the screen sharing period and the payment triggering operation. In some embodiments, the risk control operation corresponding to the payment triggering operation currently performed by the user can be determined based on association information between operation information of the sensitive operation involved in the operation record corresponding to the user equipment in the screen sharing period and the payment triggering operation, and the risk control operation is performed. The association information can refer to an association degree between the sensitive operation and the payment triggering operation, and the corresponding risk control operation is determined based on the association degree. For example, a risk control operation to which the association degree is mapped is used as the risk control operation corresponding to the payment triggering operation based on a preset mapping relationship between an association degree and a risk control operation. The association information can also refer to a degree of guidance between the sensitive operation and the payment triggering operation. The degree of guidance is used to represent an extent to which the sensitive operation guides the payment triggering operation. Then, the corresponding risk control operation is determined based on the degree of guidance. For example, based on a value interval within the degree of guidance falls and a preset mapping relationship between a value interval and a risk control operation, a risk control operation to which the value interval is mapped is used as the risk control operation corresponding to the payment triggering operation.

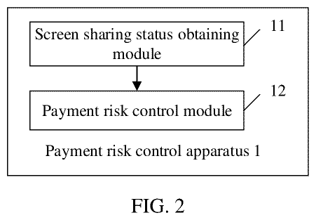

FIG. 2 is a schematic diagram of a payment risk control apparatus 1 according to an embodiment. The payment risk control apparatus 1 can be implemented as all or a part of an electronic device by using software, hardware, or a combination thereof. In some embodiments, the payment risk control apparatus 1 includes a screen sharing status obtaining module 11 and a payment risk control module 12. Each module can be implemented with hardware, software, or a combination thereof.

The screen sharing status obtaining module 11 is configured to obtain, in response to a payment triggering operation performed by a user, a screen sharing status corresponding to user equipment currently used by the user.

The payment risk control module 12 is configured to: in response to the screen sharing status indicating that the user equipment is currently engaged in screen sharing, perform a risk control operation corresponding to the payment triggering operation based on the screen sharing status.

In some embodiments, the performing the risk control operation corresponding to the payment triggering operation based on the screen sharing status includes: determining corresponding risk quantization information based on the screen sharing status; and performing the risk control operation corresponding to the payment triggering operation based on the risk quantization information.

In some embodiments, the screen sharing status includes an operation record and screen sharing duration information that correspond to the user equipment in a screen sharing period; and the determining corresponding risk quantization information based on the screen sharing status includes: determining the corresponding risk quantization information based on the operation record, the screen sharing duration information, device risk quantization information corresponding to the user equipment, and transaction volume quantization information corresponding to the user.

In some embodiments, the determining the corresponding risk quantization information based on the operation record, the screen sharing duration information, device risk quantization information corresponding to the user equipment, and transaction volume quantization information corresponding to the user includes: determining the corresponding risk quantization information based on the operation record, the screen sharing duration information, the device risk quantization information corresponding to the user equipment, the transaction volume quantization information corresponding to the user, and social relationship quantization information between the user and a payment object corresponding to the payment triggering operation.

In some embodiments, the screen sharing status includes screen content shared by the user equipment; and the performing the risk control operation corresponding to the payment triggering operation based on the screen sharing status includes: performing the risk control operation corresponding to the payment triggering operation based on the screen content shared by the user equipment.

In some embodiments, the performing the risk control operation corresponding to the payment triggering operation based on the screen content shared by the user equipment includes: performing the risk control operation corresponding to the payment triggering operation based on sensitive information included in the screen content shared by the user equipment.

In some embodiments, the performing the risk control operation corresponding to the payment triggering operation based on sensitive information included in the screen content shared by the user equipment includes: performing the risk control operation corresponding to the payment triggering operation based on association information between the sensitive information included in the screen content shared by the user equipment and screen-presented content of the user equipment within a preset time range before a screen sharing enabling time.

In some embodiments, the performing the risk control operation corresponding to the payment triggering operation based on sensitive information included in the screen content shared by the user equipment includes: performing the risk control operation corresponding to the payment triggering operation based on association information between the sensitive information included in the screen content shared by the user equipment and an operation object corresponding to the payment triggering operation.

In some embodiments, the screen sharing status includes an operation record corresponding to the user equipment in a screen sharing period; and the performing the risk control operation corresponding to the payment triggering operation based on the screen sharing status includes: performing the risk control operation corresponding to the payment triggering operation based on the operation record corresponding to the user equipment in the screen sharing period.

In some embodiments, the performing the risk control operation corresponding to the payment triggering operation based on the operation record corresponding to the user equipment in the screen sharing period includes: performing the risk control operation corresponding to the payment triggering operation based on a sensitive operation involved in the operation record corresponding to the user equipment in the screen sharing period.

In some embodiments, the performing the risk control operation corresponding to the payment triggering operation based on the sensitive operation involved in the operation record corresponding to the user equipment in the screen sharing period includes: performing the risk control operation corresponding to the payment triggering operation based on association information between the sensitive operation involved in the operation record corresponding to the user equipment in the screen sharing period and a historical operation performed by the user equipment within a preset time range before a screen sharing enabling time.

In some embodiments, the performing the risk control operation corresponding to the payment triggering operation based on a sensitive operation involved in the operation record corresponding to the user equipment in the screen sharing period includes: performing the risk control operation corresponding to the payment triggering operation based on association information between the sensitive operation involved in the operation record corresponding to the user equipment in the screen sharing period and the payment triggering operation.

The above apparatus embodiment corresponds to the method embodiment. For detailed description, reference can be made to the description in the method embodiment. Details are not described herein.

An embodiment of this specification further provides a non-transitory computer storage medium. The computer storage medium can store instructions that, when executed by a processor of an electronic device, cause the electronic device to perform the payment risk control method described above.

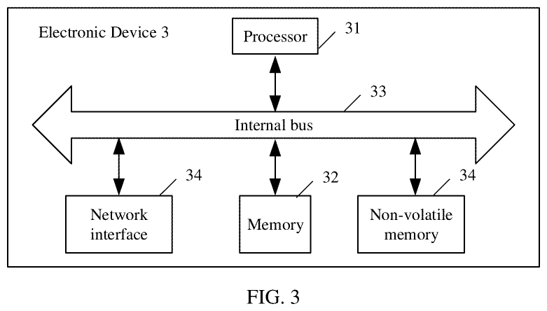

FIG. 3 is a schematic diagram of an electronic device 3 according to an embodiment. As shown in FIG. 3, the electronic device 3 includes a processor 31 and a memory 32 storing instructions executable by the processor 31. The electronic device 3 can also includes an internal bus 33, a network interface 34, a non-volatile memory 35, or other hardware as needed. The processor 31 is configured to perform the payment risk control method described above.

In some embodiments, the electronic device 3 can be user equipment, for example, a personal computer, a laptop computer, a cellular phone, a camera phone, a smartphone, a personal digital assistant, a media player, a navigation device, an email device, a game console, a tablet computer, a wearable device, or a combination of any of these devices.

Embodiments of this specification provide a payment risk control method, including: obtaining, in response to a payment triggering operation performed by a user, a screen sharing status corresponding to user equipment currently used by the user; and in response to the screen sharing status indicating that the user equipment is currently engaged in screen sharing, performing a risk control operation corresponding to the payment triggering operation based on the screen sharing status.

In some embodiments, the obtaining the screen sharing status corresponding to user equipment currently used by the user includes at least one of: determining the screen sharing status corresponding to the user equipment based on screen recording information corresponding to a current screen of the user equipment currently used by the user; or determining the screen sharing status corresponding to the user equipment based on projection information corresponding to a current screen of the user equipment currently used by the user.

In some embodiments, the performing the risk control operation corresponding to the payment triggering operation based on the screen sharing status includes: determining corresponding risk quantization information based on the screen sharing status; and performing the risk control operation corresponding to the payment triggering operation based on the risk quantization information.

In some embodiments, the screen sharing status includes an operation record and screen sharing duration information that correspond to the user equipment in a screen sharing period; and the determining corresponding risk quantization information based on the screen sharing status includes: determining the corresponding risk quantization information based on the operation record, the screen sharing duration information, device risk quantization information corresponding to the user equipment, and transaction volume quantization information corresponding to the user.

In some embodiments, the determining the corresponding risk quantization information based on the operation record, the screen sharing duration information, device risk quantization information corresponding to the user equipment, and transaction volume quantization information corresponding to the user includes: determining the corresponding risk quantization information based on the operation record, the screen sharing duration information, the device risk quantization information corresponding to the user equipment, the transaction volume quantization information corresponding to the user, and social relationship quantization information between the user and a payment object corresponding to the payment triggering operation.

In some embodiments, the screen sharing status includes screen content shared by the user equipment; and the performing the risk control operation corresponding to the payment triggering operation based on the screen sharing status includes: performing the risk control operation corresponding to the payment triggering operation based on the screen content shared by the user equipment.

In some embodiments, the performing the risk control operation corresponding to the payment triggering operation based on the screen content shared by the user equipment includes: performing the risk control operation corresponding to the payment triggering operation based on sensitive information included in the screen content shared by the user equipment.

In some embodiments, the performing the risk control operation corresponding to the payment triggering operation based on sensitive information included in the screen content shared by the user equipment includes: performing the risk control operation corresponding to the payment triggering operation based on association information between the sensitive information included in the screen content shared by the user equipment and screen-presented content of the user equipment within a preset time range before a screen sharing enabling time.

In some embodiments, the performing the risk control operation corresponding to the payment triggering operation based on sensitive information included in the screen content shared by the user equipment includes: performing the risk control operation corresponding to the payment triggering operation based on association information between the sensitive information included in the screen content shared by the user equipment and an operation object corresponding to the payment triggering operation.

In some embodiments, the screen sharing status includes an operation record corresponding to the user equipment in a screen sharing period; and the performing the risk control operation corresponding to the payment triggering operation based on the screen sharing status includes: performing the risk control operation corresponding to the payment triggering operation based on the operation record corresponding to the user equipment in the screen sharing period.

In some embodiments, the performing the risk control operation corresponding to the payment triggering operation based on the operation record corresponding to the user equipment in the screen sharing period includes: performing the risk control operation corresponding to the payment triggering operation based on a sensitive operation involved in the operation record corresponding to the user equipment in the screen sharing period.

In some embodiments, the performing the risk control operation corresponding to the payment triggering operation based on a sensitive operation involved in the operation record corresponding to the user equipment in the screen sharing period includes: performing the risk control operation corresponding to the payment triggering operation based on association information between the sensitive operation involved in the operation record corresponding to the user equipment in the screen sharing period and a historical operation performed by the user equipment within a preset time range before a screen sharing enabling time.

In some embodiments, the performing the risk control operation corresponding to the payment triggering operation based on a sensitive operation involved in the operation record corresponding to the user equipment in the screen sharing period includes: performing the risk control operation corresponding to the payment triggering operation based on association information between the sensitive operation involved in the operation record corresponding to the user equipment in the screen sharing period and the payment triggering operation.

Embodiments of this specification further provide a payment risk control apparatus, including: a screen sharing status obtaining module, configured to obtain, in response to a payment triggering operation performed by a user, a screen sharing status corresponding to user equipment currently used by the user; and a payment risk control module, configured to: in response to the screen sharing status indicating that the user equipment is currently engaged in screen sharing, perform a risk control operation corresponding to the payment triggering operation based on the screen sharing status.

Embodiments of this specification further provide an electronic device, including a processor and a storage storing instructions executable by the processor. The processor is configured to perform the payment risk control method described above.

Embodiments of this specification further provide a non-transitory storage medium storing instructions that, when executed by a processor of an electronic device, cause the electronic device to perform the payment risk control method described above.

In the embodiments of this specification, when a user performs a payment triggering operation, it is identified, based on a screen sharing status corresponding to user equipment currently used by the user, whether the user is in a high-risk, fraud-prone screen sharing environment, and a risk control operation corresponding to the payment triggering operation is performed. It is sensed whether a potential fraud victim is in a screen sharing environment, to perform proactive protection, early warning, or timely blocking and interception. This can significantly lower a risk that the user is guided to fraud in the screen sharing status, and can greatly lower a risk that the user is defrauded in a payment scenario.

This specification is described with reference to the flowcharts and/or the block diagrams of the method or device. It should be understood that each procedure and/or block in the flowcharts and/or the block diagrams and a combination of procedures and/or blocks in the flowcharts and/or the block diagrams can be implemented by using computer program instructions. These computer program instructions can be provided to a general-purpose computer, a dedicated computer, an embedded processor, or a processor of another programmable data processing device to generate a machine, so that the instructions executed by the computer or the processor of the another programmable data processing device generate an apparatus for implementing a specific function in one or more procedures in the flowcharts and/or in one or more blocks in the block diagrams.

In some embodiments, these computer program instructions can be stored in a computer-readable memory that can instruct a computer or another programmable data processing device to work in a specific manner, so that the instructions stored in the computer-readable memory generate an artifact that includes an instruction apparatus. The instruction apparatus implements a specific function in one or more procedures in the flowcharts and/or in one or more blocks in the block diagrams.

In some embodiments, these computer program instructions can be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more procedures in the flowcharts and/or in one or more blocks in the block diagrams.

It should be further noted that the terms “include”, “comprise”, or any other variants thereof are intended to cover a non-exclusive inclusion, so that a process, a method, or a device that includes a list of elements not only includes those elements but also includes other elements which are not expressly listed, or further includes elements inherent to such a process, method, or device. Without more constraints, an element preceded by “includes a . . . ” does not preclude the existence of additional identical elements in the process, method, product, or device that includes the element.

In some embodiments, the method, apparatus, or device described above can be implemented with a program module. Usually, the program module includes a routine, a program, an object, a component, a data structure, etc. for executing a specific task or implementing a specific abstract data type. In some embodiments, the method, apparatus, or device described above can alternatively be practiced in distributed computing environments. In the distributed computing environments, tasks are executed by remote processing devices connected through a communication network. In the distributed computing environments, the program module can be located in local and remote computer storage media including storage devices.

The embodiments of this specification are described in a progressive manner. For same or similar parts in the embodiments, mutual references can be made to the embodiments.

The above descriptions are merely example embodiments of this specification, and are not intended to limit this specification. A person skilled in the art can make various modifications and changes to this specification. Any modification, equivalent replacement, improvement, etc. made without departing from the spirit and principle of this specification shall fall within the scope of the claims of this specification.

1. A payment risk control method, comprising:
obtaining, in response to a payment triggering operation performed by a user, a screen sharing status corresponding to user equipment currently used by the user; and
in response to the screen sharing status indicating that the user equipment is currently in screen sharing, performing a risk control operation corresponding to the payment triggering operation based on the screen sharing status.

2. The method according to claim 1, wherein the performing the risk control operation corresponding to the payment triggering operation based on the screen sharing status comprises:
determining corresponding risk quantization information based on the screen sharing status; and
performing the risk control operation corresponding to the payment triggering operation based on the risk quantization information.

3. The method according to claim 2, wherein the screen sharing status comprises an operation record and screen sharing duration information that correspond to the user equipment in a screen sharing period; and
the determining the corresponding risk quantization information based on the screen sharing status comprises:
determining the corresponding risk quantization information based on the operation record, the screen sharing duration information, device risk quantization information corresponding to the user equipment, and transaction volume quantization information corresponding to the user.

4. The method according to claim 3, wherein the determining the corresponding risk quantization information based on the operation record, the screen sharing duration information, the device risk quantization information corresponding to the user equipment, and the transaction volume quantization information corresponding to the user comprises:
determining the corresponding risk quantization information based on the operation record, the screen sharing duration information, the device risk quantization information corresponding to the user equipment, the transaction volume quantization information corresponding to the user, and social relationship quantization information between the user and a payment object corresponding to the payment triggering operation.

5. The method according to claim 1, wherein the screen sharing status comprises screen content shared by the user equipment; and
the performing the risk control operation corresponding to the payment triggering operation based on the screen sharing status comprises:
performing the risk control operation corresponding to the payment triggering operation based on the screen content shared by the user equipment.

6. The method according to claim 5, wherein the performing the risk control operation corresponding to the payment triggering operation based on the screen content shared by the user equipment comprises:
performing the risk control operation corresponding to the payment triggering operation based on sensitive information comprised in the screen content shared by the user equipment.

7. The method according to claim 6, wherein the performing the risk control operation corresponding to the payment triggering operation based on the sensitive information comprised in the screen content shared by the user equipment comprises:
performing the risk control operation corresponding to the payment triggering operation based on association information between the sensitive information comprised in the screen content shared by the user equipment and screen-presented content of the user equipment within a preset time range before a screen sharing enabling time.

8. The method according to claim 6, wherein the performing the risk control operation corresponding to the payment triggering operation based on the sensitive information comprised in the screen content shared by the user equipment comprises:
performing the risk control operation corresponding to the payment triggering operation based on association information between the sensitive information comprised in the screen content shared by the user equipment and an operation object corresponding to the payment triggering operation.

9. The method according to claim 1, wherein the screen sharing status comprises an operation record corresponding to the user equipment in a screen sharing period; and
the performing the risk control operation corresponding to the payment triggering operation based on the screen sharing status comprises:
performing the risk control operation corresponding to the payment triggering operation based on the operation record corresponding to the user equipment in the screen sharing period.

10. The method according to claim 9, wherein the performing the risk control operation corresponding to the payment triggering operation based on the operation record corresponding to the user equipment in the screen sharing period comprises:
performing the risk control operation corresponding to the payment triggering operation based on a sensitive operation involved in the operation record corresponding to the user equipment in the screen sharing period.

11. The method according to claim 10, wherein the performing the risk control operation corresponding to the payment triggering operation based on the sensitive operation involved in the operation record corresponding to the user equipment in the screen sharing period comprises:
performing the risk control operation corresponding to the payment triggering operation based on association information between the sensitive operation involved in the operation record corresponding to the user equipment in the screen sharing period and a historical operation performed by the user equipment within a preset time range before a screen sharing enabling time.

12. The method according to claim 10, wherein the performing the risk control operation corresponding to the payment triggering operation based on the sensitive operation involved in the operation record corresponding to the user equipment in the screen sharing period comprises:
performing the risk control operation corresponding to the payment triggering operation based on association information between the sensitive operation involved in the operation record corresponding to the user equipment in the screen sharing period and the payment triggering operation.

13. An electronic device, comprising:
a processor; and
a storage storing a computer program executable by the processor,
wherein the processor is configured to:
obtain, in response to a payment triggering operation performed by a user, a screen sharing status corresponding to user equipment currently used by the user; and
in response to the screen sharing status indicating that the user equipment is currently in screen sharing, perform a risk control operation corresponding to the payment triggering operation based on the screen sharing status.

14. The electronic device according to claim 13, wherein in performing the risk control operation corresponding to the payment triggering operation based on the screen sharing status, the processor is further configured to:
determine corresponding risk quantization information based on the screen sharing status; and
perform the risk control operation corresponding to the payment triggering operation based on the risk quantization information.

15. The electronic device according to claim 14, wherein the screen sharing status comprises an operation record and screen sharing duration information that correspond to the user equipment in a screen sharing period; and
in determining the corresponding risk quantization information based on the screen sharing status, the processor is further configured to:
determine the corresponding risk quantization information based on the operation record, the screen sharing duration information, device risk quantization information corresponding to the user equipment, and transaction volume quantization information corresponding to the user.

16. The electronic device according to claim 15, wherein in determining the corresponding risk quantization information based on the operation record, the screen sharing duration information, the device risk quantization information corresponding to the user equipment, and the transaction volume quantization information corresponding to the user, the processor is further configured to:
determine the corresponding risk quantization information based on the operation record, the screen sharing duration information, the device risk quantization information corresponding to the user equipment, the transaction volume quantization information corresponding to the user, and social relationship quantization information between the user and a payment object corresponding to the payment triggering operation.

17. The electronic device according to claim 13, wherein the screen sharing status comprises screen content shared by the user equipment; and
in performing the risk control operation corresponding to the payment triggering operation based on the screen sharing status, the processor is further configured to:
perform the risk control operation corresponding to the payment triggering operation based on the screen content shared by the user equipment.

18. The electronic device according to claim 17, wherein in performing the risk control operation corresponding to the payment triggering operation based on the screen content shared by the user equipment, the processor is further configured to:
perform the risk control operation corresponding to the payment triggering operation based on sensitive information comprised in the screen content shared by the user equipment.

19. The electronic device according to claim 13, being the user equipment.

20. A non-transitory computer-readable storage medium storing instructions that, when executed by a processor of an electronic device, cause the electronic device to perform a payment risk control method, the method comprising:
obtaining, in response to a payment triggering operation performed by a user, a screen sharing status corresponding to user equipment currently used by the user; and
in response to the screen sharing status indicating that the user equipment is currently in screen sharing, performing a risk control operation corresponding to the payment triggering operation based on the screen sharing status.
